(19) United States
(12) Patent Application Publication
(10) Pub. No.: US 2004/0002578 A1
(43) Pub. Date: Jan. 1, 2004

(54) AIRq'2-type aluminum compound and method for manufacturing the same and derivative thereof

(75) Inventors: Takakazu Yamamoto, Yokohama City (JP); Isao Yamaguchi, Yamato City (JP); Takayuki Iijima, Yokohama City (JP)

Correspondence Address: OLIFF & BERRIDGE, PLC, P.O. BOX 19928, ALEXANDRIA, VA, 22320, US

(73) Assignee: Tokyo Institute of Technology, Tokyo (JP)

(21) Appl. No.: 10/361,575

(22) Filed: Feb. 11, 2003

(30) Foreign Application Priority Data
Jun. 27, 2002 (JP) 2002-187,795

(51) Int. Cl. C08G 63/78; C08G 63/87; C07F 5/06

(52) U.S. Cl. 528/205; 546/10

(57) ABSTRACT

By reacting trialkyl aluminum (AlR₃) with 2-position substituted 8-quinolinol (q′H) at a mole ratio of 1:2, an AlRq′₂-type aluminum compound having a specified structural formula is manufactured. The resulting compound is further reacted with an active hydrogen-containing organic compound to obtain a derivative such as an Alq′₂q type derivative (wherein q represents 8-quinolinolato ligand and q′ represents 2-position substituted 8-quinolinolato ligand).

### BACKGROUND OF THE INVENTION

1. Field of the Invention

This invention relates to an AlRq′₂-type compound and a method for manufacturing the same and a derivative thereof, and more particularly to a novel AlRq′₂-type aluminum compound having a highly reactive alkyl-aluminum bond (Al—R) and a method for manufacturing the same and the derivative manufactured by means of a highly reactivity thereof and suitable for an organic light emitting device (OLED) and the like.

2. Description of Related Art

Since an aluminum complex having three 8-quinolinolato ligands (q), [tri (8-quinolinolato) aluminum complex: Alq₃] has a good light emitting property and an electron transmitting property, it is applied to and industrially used in an electro-luminescence element.

In order to control an emitted wavelength and improve a light emitting intensity, there have been synthesized many aluminum complexes having a quinolinol ring with a substituent(s).

Further, many aluminum compounds formed from two 8-quinolinolato ligands and a phenol derivative have been synthesized. It was reported in, for example, U.S. Pat. No. 5,141,671 that the optical properties of these aluminum compounds highly depend on a structure of the phenol derivative. They are manufactured through the following process having two steps. That is, Al(OR)₂(q) is first synthesized by reacting 8-quinolinol with trialkoxy aluminum [Al(OR)₃)] at a mole ratio of 1:1, subsequently the synthesized compound is reacted with a mixture of 8-quinolinol and a phenol derivative (HOC₆HₘX₅₋ₘ, wherein X represents methyl group, butyl group, or phenyl group and m represents an integer of not more than 5) to form an aluminum compound [Al(OC₆HₘX₅₋ₘ)q₂]. According to this process, however, Alq₃ is necessarily produced as a by-product.

Meanwhile, it is known that the alkyl-aluminum bond has a high reactivity and therefore easily reacts with olefins or alcohols. Accordingly, the aluminum compound (AlRq₂) constituted by one alkyl-aluminum bond and two 8-quinolinolato ligands can be converted to various aluminum compounds such as the above-mentioned Al(OC₆HₘX₅₋ₘ)q₂.

However, only few examples of the aluminum compound having the reactive alkyl-aluminum bond have been reported. Besides, as the reactive aluminum compound, there is merely reported an example of aluminum compound having a hydroxyl group [Al(OH)q′₂: wherein q′ represents 2-methyl-8-quiolinolato.] is reported.[L. M. Leung et al., J. Am. Chem. Soc., 122,5640(2000)].

Although some trials of the synthesis of AlRq₂-type aluminum compound (R: methyl group or ethyl group) were performed up to the present, any trials could not have attained to obtain the aimed aluminum compound. For example, it is reported that the reaction of 8-quinolinol with trialkyl aluminum does not produce an aluminum compound (AlRq₂) consisting of one alkyl-aluminum bond and two quinolinolato ligands but produce binuclear aluminum compound ([AlR₂q]₂) and Alq₃.[T. J. Hurley et al., Inorg. Chem., 6,1311 (1967)].

### SUMMARY OF THE INVENTION

Therefore, it is an object of the invention to provide an objective aluminum compound having the alkyl-aluminum bond while controlling the production of the by-products such as the above-mentioned binuclear aluminum compound ([AlR₂q]₂), Alq₃ and the like, and an derivative derived therefrom by using the reactivity in the bond.

In order to attain the above-mentioned object, the invention has the following structure:

That is, AlRq′₂-type aluminum compound in accordance with the present invention is characterized in that the compound is shown by the following general formula (I):

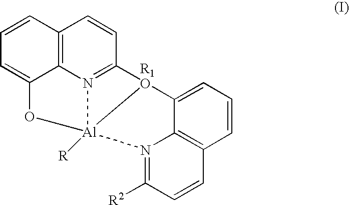

wherein R represents an alkyl group with a carbon number of not more than 6, such as methyl group, ethyl group, propyl group or the like, R¹ and R² respectively represent an alkyl group with a carbon number of not more than 6, such as methyl group, ethyl group, propyl group or the like; an alkoxy group with a carbon number of not more than 6, such as methoxy group, ethoxy group, propoxy group or the like; or a dialkylamine group having a carbon number of not more than 6 (NR′R″: R′ and R″ respectively present an alkyl group having a carbon number of not more than 3).

In the above formula, the kind of the functional group and the number of carbon is limited in order to avoid a bad influence of steric hindrance.

Furthermore, the AlRq′₂-type aluminum compound in accordance with the present invention is characterized in that the compound is manufactured by reacting a trialkyl aluminum (AlR₃) with 2-position substituted 8-quinolinol (q'H) at a mole ratio of 1:2. Although the ration of molecules to be reacted is 1:2, the molar ratio of the compounds added in the reaction system is sufficient to satisfy a condition that the reaction proceeds substantially at the molar ratio of 1:2.

It is considered that when a 2-position substituted 8-hydroxyquinolinol (q'H) formed by introducing a substituent such as methyl group or the like into 2-position is used as a substrate, the aimed AlRq′₂-type aluminum compound can be obtained by a steric effect of such a substituent in the reaction with the trialkyl aluminum while controlling the formation of the by-product such as a dimmer of [AlR₂q′] or Alq′₃.

Moreover, a derivative derived from the AlRq′₂-type aluminum compound in accordance with the present invention is characterized in that the derivative is produced by reacting the AlRq′₂-type aluminum compound with an active hydrogen-containing organic compound. In this case, the active hydrogen-containing compound is not limited to a low molecular weight substrate but includes a high molecular weight one containing the active hydrogen. As the active hydrogen-containing organic compound, 8-quinolinole, phenol, aniline, thiol or a derivative thereof is favorably used. The derivatives are concretely shown below. The 8-quinolinol derivatives may include 3-alkyl-8-quinolinol, 4-alkyl-8-quinolinol, 5-alkyl-8-quinolinol, 6-alkyl-8-quinolinol, 7-alkyl-8-quinolinol and the like, in this case, the alkyl group is preferable to be methyl or ethyl group; and further 3-halo-8-quinolinole, 4-halo-8-quinolinole, 5-halo-8-quinolinole, 6-halo-8-quinolinole, 7-halo-8-quinolinole, 3,5-dihalo-8-quinolinole, 3,6-dihalo-8-quinolinole, 3,7-dihalo-8-quinolinole, 4,6-dihalo-8-quinolinole, 4,7-dihalo-8-quinolinole, 5,7-dihalo-8-quinolinole and the like, in this case, the halogen is preferable to be chlorine or bromine. The phenol derivatives may include 4-alkyl phenol, 4-alkoxy phenol and the like. In this case, the alkyl or alkoxy group is preferable to be a straight chain or branched chain group having a carbon number of not more than 6 (for instance, tert-butyl group). The aniline derivatives may include aniline, 4-alkylaniline and the like. In this case, the alkyl group is preferable to be a straight chain or branched chain group having a carbon number of not more than 6. The thiol derivatives may include thiophenol, alkylthiol and the like. In this case, the alkyl group is preferable to have a carbon number of not more than 4.

Among these derivatives, Alq′₂q-type derivatives (q: 8-quinolinorato ligand, q′: 2-position substituted 8-quinolinorato ligand) are particularly preferable as a material for the OLED. In case of using this derivative as a light-emitting material, the compound can be used as a thin film or the like by subjecting to a vacuum deposition.

Furthermore, a polymer in accordance with the present invention is characterized in that the polymer has a repeating unit shown by the following general formula (II) or (III):

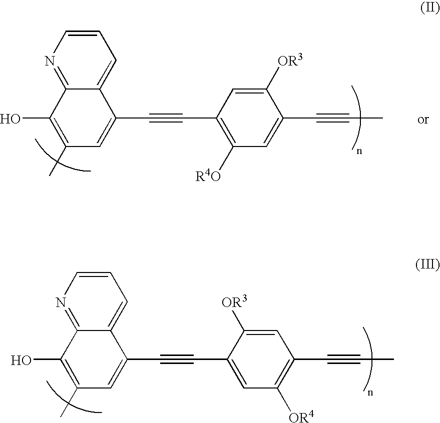

wherein R³ and R⁴ represent a straight chain or branched chain alkyl group having a carbon number of not more than 20, respectively, n represents an integer of 2 through 50. In the above formula, the limitation of the carbon number to not more than 20 is based on the fact that when the compound is used as the light-emitting material, since it is dissolved in a solvent and then shaped into a thin film, the solubility of the compound in such a solvent should be considered. On the other hand, the limitation of the polymerization degree to the above range is based on the fact that the molecular weight suitable for the formation of the thin film is obtained in use.

By reacting the polymer as the active hydrogen-containing organic compound with the aluminum compound having a high reactivity according to the present invention, a light-emitting polymer having the excellent light-emitting properties as the derivative of the aluminum compound can be obtained.

The AlEtq′₂, for instance, according to the present invention reacts with the quinolinol ligand having the active hydrogen, and can easily react with a phenolic OH group under specific conditions such as in tetrahydrofuran. However, it does not react with a secondary amine.

### BRIEF DESCRIPTION OF THE DRAWING

The present invention will be further explained in detail hereinafter with reference to the accompanying drawing, in which:

FIG. 1 is a ¹H-NMR spectrum in CD₂Cl₂;

FIG. 2 is an absorbance in an UV-vis spectrum of Alq₃, AlEtq′₂, and Alqq′₂ in CHCl₃;

FIG. 3 is an intensity of luminescence and absorbance in a PL spectrum of Alq₃, AlEtq′₂, and Alqq′₂ in CHCl₃;

FIG. 4 is an IR spectrum of a synthesized polymer a′;

FIG. 5 is an UV-vis spectrum of the polymer a′;

FIG. 6 is a PL spectrum of the polymer a′;

FIG. 7 is a scheme showing a reaction process of the polymer and AlEtq′₂; and

FIG. 8 is a scheme showing a repeating unit of a polymer b′ and a graph showing a ¹H-NMR spectrum of the polymer.

### DETAILED DESCRIPTION OF THE INVENTION

The present invention will be described in more detail below based on examples, but it is not intended to limit the present invention.

All reactions and manipulations are carried out in an inert gas using a standard Schlenk technique. All solvents are dried and distilled prior to use. IR, ¹H-NMR and ¹³C NMR spectra are measured and recorded by means of a JASCO-IR 810 spectrophotometer and JEOL EX-400 spectrometer, respectively. Elemental analysis is carried out with a Yanagimoto Type MT-2 CHN auto-coder. X-ray crystallographic analysis is also performed.

### EXAMPLE 1

### Manufacture of AlRq′₂ Type Aluminum Compound in Accordance with the Present Invention

To a C₆H₅CH₃ solution (50 ml) of AlEt₃ (4.60 ml, 30.0 mmol) is added dropwise a C₆H₅CH₃ solution (80 ml) of 2-methyl-8-quinolinol (9.55 g, 60.0 mmol) at room temperature for one hour. After stirring at room temperature for 12 hours, the resulting precipitate is separated therefrom and the obtained filtrate is dried under vacuum to obtain an aluminum compound (AlEtq′₂ type) as a yellow solid (10.9 g) in a yield of 97%.

A structural formula of the compound is shown below.

Observed value: C 70.81; H 5.39; N 7.49%

Calculated value for C₂₂H₂₁AlN₂O₂: C 70.76; H 5.68; N 7.52% 1H-NMR(400 MHz, CD₂Cl₂): δ 8.23 (d, 2H), 7.45 (d, 2H), 7.13 (dd, 2H), 6.91 (dd, 2H), 3.07 (s, 12H), 0.70 (t, 3H), 0.13 (m, 1H), 0.06 (m, 1H).

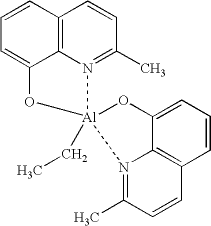

The resulting aluminum compound is soluble in tertahydrofuran, chloroform, or dichloromethane.

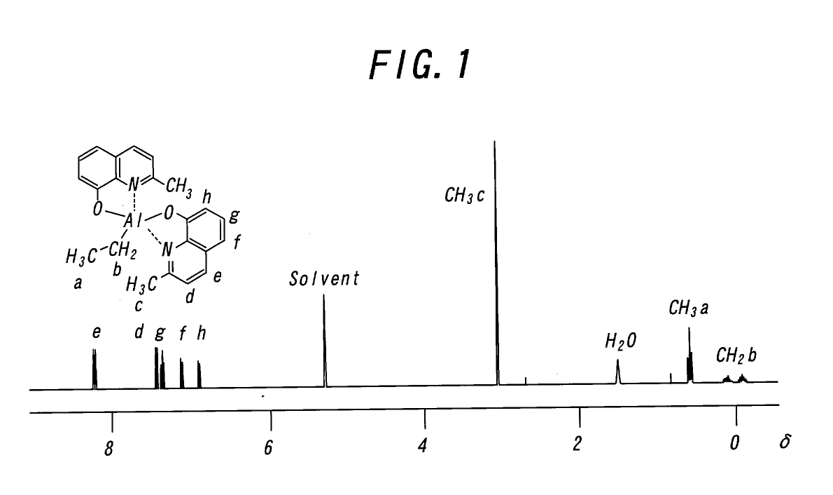

FIG. 1 depicts ¹H-NMR spectrum of the product. The spectrum of the product shows peaks due to aromatic hydrogen in a range of δ 6.91-8.23. The CH₃ peak is observed at a lower magnetic field (δ 3.07) than that of 2-methyl-8-quinolinol (δ 2.70) presumably due to a magnetically anisotropic effect in the aluminum complex. The methyl hydrogen atoms of the Et group give a triplet signal at δ 0.59. The methylene hydrogen atoms bonded to Al afford two multiples centered at δ 0.06 and 0.13, revealing that the Al center has a chirality and the CH₂ hydrogen atoms become diastereotopic due to the chirality. Integral ratio of the 1H NMR peaks and analytical data support the structure described above.

### EXAMPLE 2

### Manufacture of a Derivative 1 (Alq′₂q Type) Derived from AlRq′₂ Type Aluminum Compound in Accordance with the Present Invention

To a C₆H₅CH₃ solution (20 ml) of aluminum compound (AlEtq′₂) (1.01 g, 2.71 mmol) obtained in Example 1 is added dropwise a C₆H₅CH₃ solution (10 ml) of 8-quinolinol (0.42 g, 2.89 mmol) at room temperature for one hour. The resulting reaction mixture is stirred at room temperature for six hours. The resulting precipitate is washed with C₆H₅CH₃, dried under vacuum and recrystallized from a CH₂Cl₂ solution at room temperature to obtain a derivative 1 (Alq′₂q type) as a yellow needle crystal (0.36 g) in a yield of 27%. A structural formula of this derivative is shown below.

Observed value: C 62.84; H 4.14; N 7.59; Cl 12.14%

Calculated value for C₂₉H₂₂AlN₃O₃CH₂Cl₂: C 62.95; H 4.23; N 7.34; Cl 12.39%

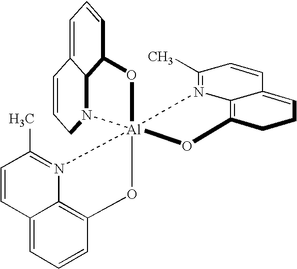

The resulting derivative 1 as an aluminum complex is soluble in tetrahydrofuran, chloroform, or dichloromethane.

The crystal data of the derivative 1, C₂₉H₂₂AlN₃O₃CH₂Cl₂ are shown below.

M=572.43 monoclinic system; space group P2_{1/C} (No. 14); a=11.386(4) Å; b=13.571(2) Å; c=17.064(3) Å; β=95.09(2)°; V=2026.4(1) Å³; Z=4; Dc=1.448Mgm⁻³; F(000)=1184.00

The diffraction data are collected with a Rigaku AFC5R diffractometer at ambient temperature (23° C.) using the ω scan mode (20≦55°). Correction for Lorentz and polarization effects and an empirical absorption correction (ψ scan) are applied to the data. The structure is solved by a common combination of direct methods (SIR-92) and subsequent Fourier techniques. The positional and thermal parameters of non-hydrogen atoms are refined anisotropically, while hydrogen atoms are located by assuming the ideal geometry.

Further, the starting material can be recovered by reacting the aluminum compound obtained in Example 1 with 2-methyl-8-quinolinol. This shows that the formation of Alq′₃ is difficult due to the steric hindrance.

The derivative 1 is stable in a solid state to air, while the solution of the derivative 1 in a THF is gradually decomposed in air.

Bond distances determined by X-ray crystallography are shown below.

Al(1)-O(1) 1.837(6); Al(1)-O(2) 1.830(6); Al(1)-O(3) 1.852(6)

Al(1)-N(1) 2.090(6); Al(1)-N(2) 2.087(7); Al(1)-N(3) 2.101(8)

The derivative 1 as the complex contains a solvated CH₂Cl₂ molecule used as a recrystallization solvent, which has a six-coordinate octahedron structure similar to Alq₃. The Al—N bond distances of the derivative 1 are similar to those of Alq₃, whereas the Al—O bond distances of the derivative 1 are somewhat shorter than those of Alq₃. As described above, the complex is expected to serve as a starting material of aluminum complexes.

### EXAMPLE 3

### Manufacture of a Derivative 2 Derived from AlRq′₂ Type Aluminum Compound in Accordance with the Present Invention

To a THF solution (30 ml) of the aluminum compound (AlEtq′₂) (0.37 g, 1.0 mmol) obtained in Example 1 is added 4-hexylphenol (0.22 g, 1.2 mmol), and the mixture is stirred at 60° C. for four hours. Then, the solvent is distilled off, and the residue is washed with ethanol to obtain a derivative [Al(OC₆H₄-p-C₄H₉)(q′)₂].

### EXAMPLE 4

### Optical Properties of Alq₃, AlEtq′₂ and Alqq′₂

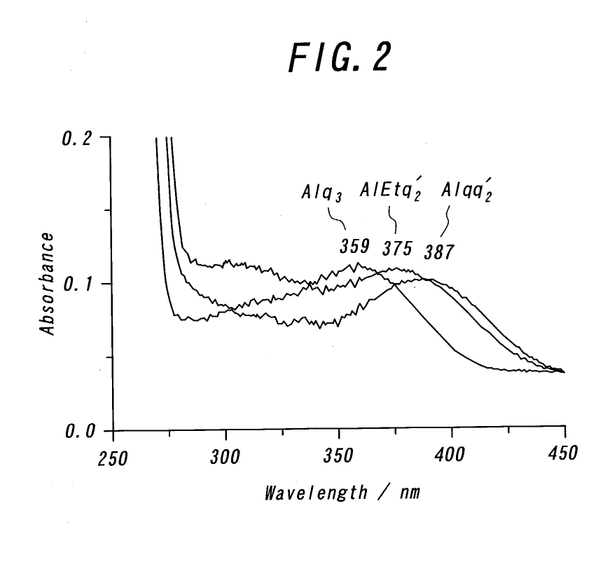

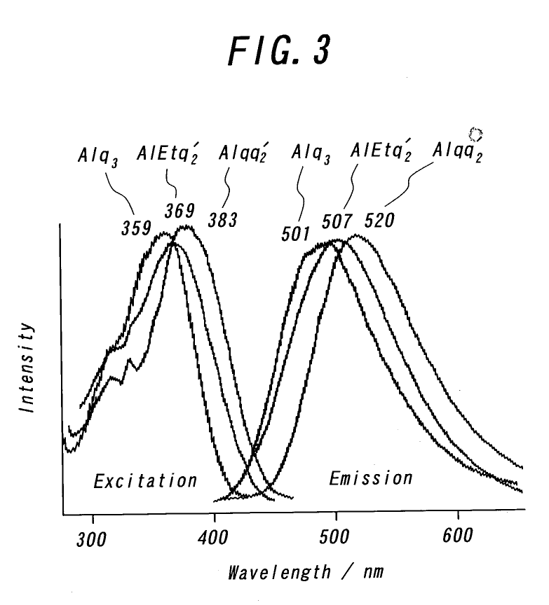

FIG. 2 shows absorbances in UV-spectra of Alq₃, AlEtq′₂ and Alqq′₂ in CHCl₃. FIG. 3 shows light emitting and absorbance intensities in PL-spectra of Alq₃, AlEtq′₂ and Alqq′₂ in CHCl₃

### EXAMPLE 5

### Synthesis of Polymer a

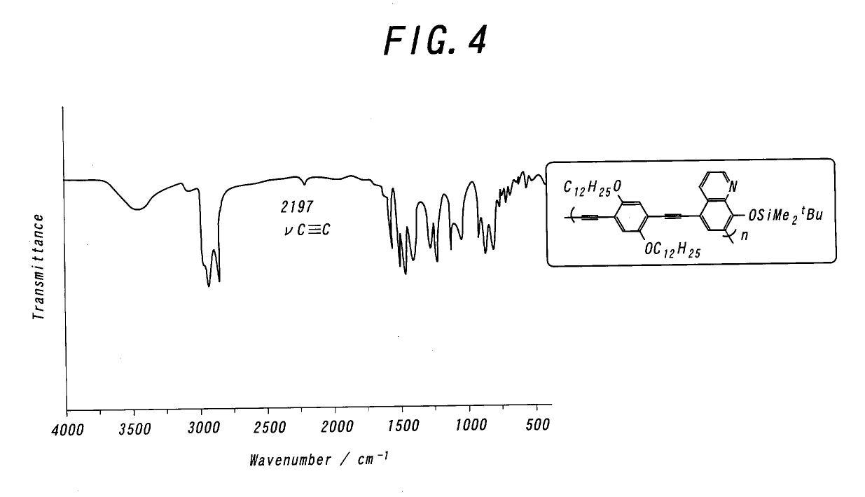

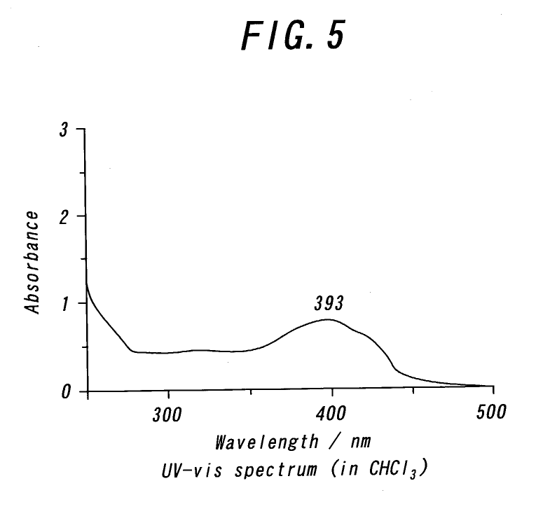

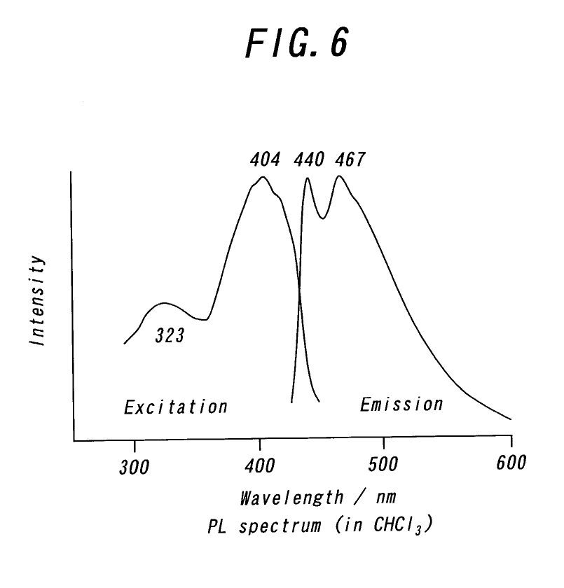

To a toluene solution (30 ml) of 5,7-dibromo-8-t-butyldimethylsiloxyquinoline (670 mg, 1.6 mmol) is added dropwise a triethyl amine solution (30 ml) of copper iodide (9.0 mg, 0.047 mmol), tetrakis (triphenylphosphine) palladium (190 mg, 0.047 mmol), and 1,4-diethynyl-2,5-didodesiloxybenzen (790 mg, 1.6 mmol) in nitrogen stream at room temperature for one hour. The reactive solution is stirred at 70° C. for 48 hours. After the solvent is distilled off under a reduced pressure, the residue is dissolved in chloroform. The insoluble matter is filtered on Celite and then the filtrate is pored into methanol to re-precipitate polymer. After the re-precipitation is repeated two times, the resulting precipitates are dried under a reduced pressure to obtain polymer protected with a hydroxyl group in a yield of 90%. The IR spectrum of the polymer a′ is shown in FIG. 4, UV-vis-spectrum in FIG. 5, and the PL spectrum in FIG. 6 (wherein the polymer a′ is a polymer which is protected with a hydroxyl group).

Subsequently, the protection removal is performed as follows. To a tetrahydrofuran solution (50 ml) of the polymer a′ (880 mg, 1.17 mmol) is added dropwise a 1M tetrahydrofuran solution of terabutylammonium fluoride (0.76 ml, 2.9 mmol) at room temperature, and the mixture is stirred at room temperature for one hour. To the reaction solution is added a distillated water (100 ml) and extracted with chloroform. After an organic phase is dried with sodium sulfate, the solvent is distilled off under a reduced pressure to obtain an objective polymer a in a yield of 99%.

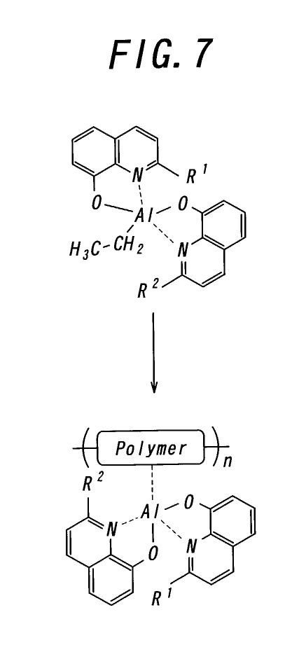

Reaction of the resulting polymer a with, for example, AlEtq′₂ provides a light emitting macromolecule suitable for use as an electroluminescence material (see: FIG. 7).

### EXAMPLE 6

### Synthesis of Polymer b

To tetrahydrofuran solution (15 ml) of 5,7-dibromo-8-t-butyldimetylsiloxyquinoline (170 mg, 0.40 mmol) is added dropwise a trietylamine solution (5 ml) of copper iodide (5.0 mg, 0.026 mmol), tetrakis (triphenylphosphine) palladium (20 mg, 0.017 mmol), and 1,4-diethynyl-2,5-dihexysiloxybenzen (130 mg, 0.40 mmol) in nitrogen stream at room temperature for 30 minutes. The reaction solution is stirred at 60° C. for 15 hours, and subsequently refluxed for 7 hours. After the solvent is distilled off under a reduced pressure, the residue is dissolved in chloroform. The insoluble matter is filtered on Celite and then the filtrate is pored into methanol to re-precipitate polymer. After the re-precipitation is repeated two times, the resulting precipitates are dried under a reduced pressure to obtain macromolecule b′ protected with a hydroxyl group in a yield of 50%.

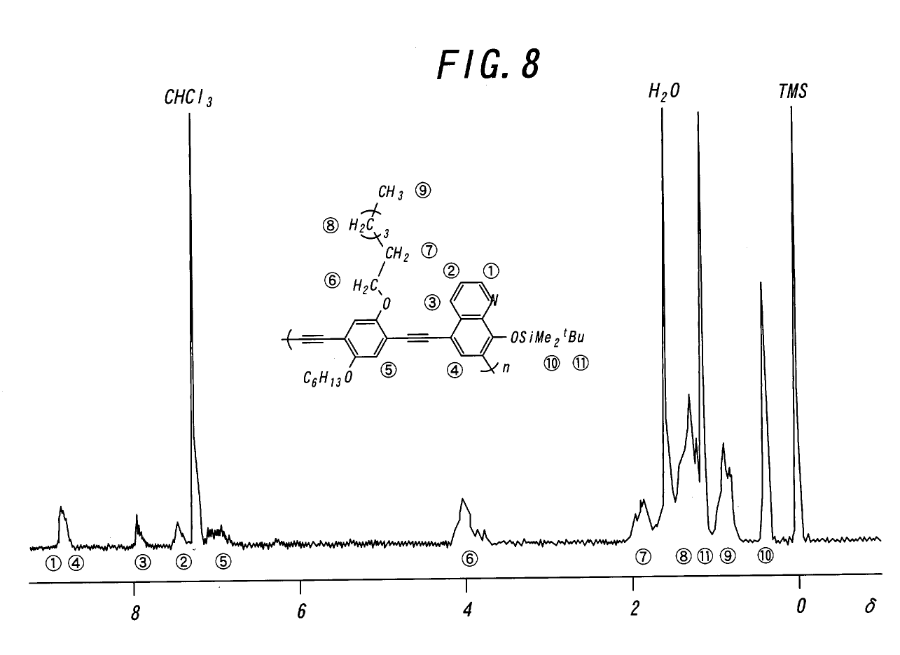

Subsequently, the protection removal is performed as follows to obtain an aimed polymer b. To a tetrahydrofuran solution (10 ml) of the polymer b′ (51 mg, 0.14 mmol) is added dropwise a tetrahydrofuran solution (1M) of terabutylammonium fluoride at room temperature, and the mixture is stirred at room temperature for one hour. The reaction solution is added with a distilled water (5 ml) and extracted with chloroform. After the organic phase is dried with sodium sulfate, the solvent is distilled off under a reduced pressure to obtain an objective polymer b in a yield of 14%. A ¹H-NMR spectrum of the polymer b′ together with a repeating unit thereof are shown in FIG. 8 (wherein the polymer b′ is a polymer protected with a hydroxyl group). As shown above, a light emitting polymer suitable for use as an electroluminescence material can be manufactured by reacting the polymer with, for example, AlEtq′₂.

As described above, it is possible to synthesize aluminum compound derivatives having excellent light emitting property and electron transmitting property by reacting the AlRq′₂ type aluminum compound in accordance with the present invention having a reactive alkyl-aluminum bond with various compounds having an active hydrogen.

What is claimed is:

1. An AlRq′₂-type aluminum compound shown by the following general formula (I): 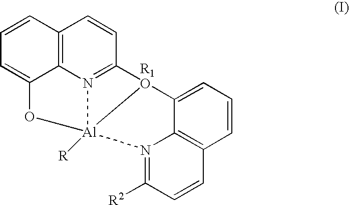
wherein R represents an alkyl group with a carbon number of not more than 6, R¹ and R² respectively represent an alkyl group, alkoxy group, or dialkylamine group (NR′R″: wherein R′ and R″ respectively represent an alkyl group having a carbon number of not more than 3.) having a carbon number of not more than 6.

2. A method for manufacturing an AlRq′₂-type aluminum compound according to claim 1, which comprises reacting trialkyl aluminum (AlR₃) with 2-position substituted 8-quinolinol (q′H) at a mole ratio of 1:2.

3. A derivative derived from an AlRq′₂-type aluminum compound produced by reacting an AlRq′₂-type aluminum compound according to claim 1 with an active hydrogen-containing organic compound.

4. A derivative according to claim 3, wherein the active hydrogen-containing organic compound is at least one selected from the group consisting of 8-quinolinole, phenol, aniline, thiol and a derivative thereof.

5. A derivative according to claim 3, wherein the derivative is an Alq′₂q-type aluminum compound and q is 8-quinolinol.

6. A polymer having a repeating unit shown by the following general formula (II) or (III): 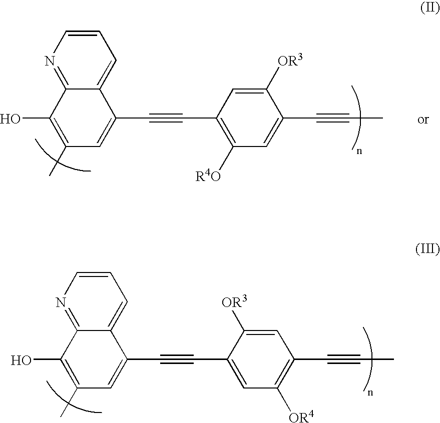
wherein R³ and R⁴ respectively represent a normal chain or branched chain alkyl group having a carbon number of not more than 20, and n represents an integer of 2 to 50.

7. A derivative according to claim 3, wherein the active hydrogen-containing organic compound is a polymer according to claim 6.
